(19) United States
(12) Patent Application Publication
(10) Pub. No.: US 2011/0121707 A1
(43) Pub. Date: May 26, 2011

(54) LED BULB FOR REPLACING A HALOGEN BULB IN THE FORM OF REFLECTIVE CUP

(76) Inventor: Jinjing Fan, Shanghai (CN)

(21) Appl. No.: 12/991,906

(22) PCT Filed: May 27, 2008
(86) PCT No.: PCT/CN2008/071103

§ 371 Date: Feb. 8, 2011

(30) Foreign Application Priority Data
May 9, 2008 (CN) 200810037241.8

(51) Int. Cl. H01J 61/52; H01K 1/30

(52) U.S. Cl. 313/46; 313/110

(57) ABSTRACT

A LED bulb for replacing a halogen bulb in the form of reflective cup comprises a housing (1), a collective lens (2), a LED circuit board (3), a number of LED chips (4) provided on the LED circuit board (3), a heat radiator (6) and a driver (7). The LED circuit board (3) is provided in the cavity (12) of the housing (1) and is connected to the heat radiator (6). The collective lens (2) is provided at the lower opening of the cavity (12). The housing (1), the heat radiator (6) and the driver (7) are connected in sequence from the bottom up. A circular ring (10) is provided on the outer wall of the lower end of the housing (1), and the circular ring (10) is detachably connected to the housing (1). The external diameter of the circular ring (10) is equal to the external diameter of the reflective cup (91) of the halogen bulb (9), and the height of the circular ring (10) is equal to the height of the annular flange of the reflective cup (91). The external diameter of the heat radiator (6) is not larger than the assembling external diameter of the lamp socket (8) for the halogen bulb (9).

### TECHNICAL FIELD

The present invention relates to an illumination device, and particularly to a LED bulb.

### BACKGROUND ART

A reflect cup shaped halogen lamp is a kind of light apparatus often used in the places like shop, supermarket, hotel and so on, which comprises a reflect cup shaped halogen bulb and a mounting base used to allow the bulb to be mounted on the ceiling. FIGS. 5A and 5B show the outline view of the prior art reflect cup shaped halogen bulb and the schematic assembly view thereof, respectively. As shown in FIG. 5A, the reflect cup shaped halogen bulb 9 comprises a reflect cup 91 under which there is disposed an annular flange 911, precisely by means of the annular flange 911, the reflect cup shaped halogen bulb 9 can be fixed in the mounting base 8 of FIG. 5B. In FIG. 5B, on the ceiling 100 there is provided a mounting hole 110 within which the mounting base 8 is inserted, a diameter of the mounting hole matches with a mounting outer diameter D0 of the mounting base. The mounting base 8 is fixed on the ceiling 100 by spring clamps 82 disposed on lugs 81 at the two sides thereof.

The working power of the prior halogen bulb is usually 20 W to 50 W and the bulb has high luminous intensity, but has the disadvantages of low efficiency (about 10-20 lm/w), large power consumption and short service life (usually 1000 to 2000 h). Therefore, it is envisaged to replace the prior halogen bulb with the LED bulb. The LED bulb has the advantages of high efficiency (about 100 lm/w), long service life (about 50000 h) and full colour temperature(2800k to 6500k), but has poor heat dissipation, so it must dissipate the heat by heat conduction. If we want to let the LED bulb to have the luminance of the prior reflect cup shaped halogen bulb, it must have larger heat dissipation area. Now, some manufacturers have developed the LED mounting base for ceiling lamp, the LED mounting base is integrated with the LED bulb, so that the LED bulb can use the volume of the LED mounting base to solve the heat dissipation problem. However, this kind of product may introduce some problems in use, for example: 1. If there is a need to replace the LED bulb, the LED mounting base must be replaced together with it, because the LED mounting base is integrated with the LED bulb, so as to induce the waste of resources; 2. Users who use the reflect cup shaped halogen bulb before can no longer use the previous mounting base, and if they want to use the LED bulb, they must mount it again, leading inconvenience.

### DISCLOSURE OF THE INVENTION

The technical problem to be solved by the invention is to provide a LED bulb for replacing the reflect cup shaped halogen bulb, which can be used with the mounting base of the prior reflect cup shaped halogen lamp.

A further problem to be solved by the invention is to provide a LED bulb for replacing the reflect cup shaped halogen bulb, which can achieve the luminance of the prior reflect cup shaped halogen bulb.

The technical solution of the invention is to provide a LED bulb for replacing the reflect cup shaped halogen bulb, which can be used with the mounting base of the reflect cup shaped halogen bulb, characterized in that, the LED bulb comprises a shell, a collective lens, a LED circuit board, one or more LED chips arranged on the LED circuit board, a radiator and a driver; the shell has a hollow structure; the LED circuit board is disposed within a cavity of the shell and connected to the radiator; the collective lens is disposed at the lower end portion of the cavity of the shell; the shell, the radiator and the driver are connected to each other from bottom to top in sequence; on a circumferential exterior wall at a lower end of the shell there is also disposed a circular ring, the circular ring is removably connected to the shell, an outer diameter and a height of the circular ring are equal to an outer diameter of the reflect cup of the reflect cup shaped halogen bulb and a height of an annular flange of the reflect cup, respectively; the outer diameter of the radiator is less than or equal to a mounting outer diameter of the mounting base.

In the above LED bulb for replacing the reflect cup shaped halogen bulb, the radiator comprises a first radiator portion and a second radiator portion located under the first radiator portion and connected thereto; an outer diameter D1 of the first radiator portion and an outer diameter D2 of the second radiator portion meet this formula: D2<D1; and, when the LED bulb is mounted to the mounting base of the reflect cup shaped halogen bulb, a distance from the lower end of the first radiator portion to the bottom face of the mounting base is larger than a height of the mounting base.

In the above LED bulb for replacing the reflect cup shaped halogen bulb, the radiator is constituted of a central post, a plurality of fins disposed on the circumferential outer wall of the central post in a radiating spaced configuration, and a bossing disposed around the outside of said plurality of fins; each of the fins is constituted by an upper wing and a lower wing integrated with the upper wing, and a width of the upper wing is larger than that of the lower wing; the bossing is disposed at the outside of the upper wings; the upper wings of the plurality of fins and the bossing constitute the first radiator portion of the radiator, and the lower wings of the plurality of fins constitute the second radiator portion of the radiator.

By adopting the above technical solution, the circular ring disposed on the shell can have the function of the annular flange of the reflect cup of the prior reflect cup shaped halogen bulb, so that the LED bulb of the invention can be mounted within the mounting base of the prior reflect cup shaped halogen bulb for use, reducing the inconvenience due to the adaption of the LED bulb by the users of the prior halogen bulb and decreasing the cost. Further, when the LED bulb of the invention is broken down, it only needs to replace the LED bulb without simultaneously replacing the mounting base, so as to avoid the waste of resources. With enabling the LED bulb of the invention to be mounted to the prior mounting base, the radiator structure of the invention has optimized the heat dissipation area and improved the heat dissipation efficiency, so as to allow the LED bulb of the invention to achieve the lumination of the prior reflect cup shaped halogen bulb.

### BRIEF DESCRIPTION OF THE DRAWINGS

FIG. 1 is an exploded view in a perspective of the LED bulb for replacing the reflect cup shaped halogen bulb according to the invention;

FIG. 2A is a schematic outline view of the LED bulb for replacing the reflect cup shaped halogen bulb according to the invention;

FIG. 2B is a top view of FIG. 2A;

FIG. 2C is a bottom view of FIG. 2A;

FIGS. 3A, 3B and 3C are the assembly schematic drawings of the LED bulb for replacing the reflect cup shaped halogen bulb according to the invention and the prior three kinds of the mounting base of the reflect cup shaped halogen bulb, respectively;

FIG. 4A is an assembly schematic drawing of the LED bulb for replacing the reflect cup shaped halogen bulb according to the invention, which is mounted to the mounting base;

FIG. 4B is an assembly schematic drawing of the LED bulb for replacing the reflect cup shaped halogen bulb according to the invention, which is in the rotation state after mounted to the mounting base;

FIGS. 5A and 5B are an outline view and an assembly schematic drawing of the prior reflect cup shaped halogen bulb, respectively.

### BEST MODE FOR CARRYING OUT THE INVENTION

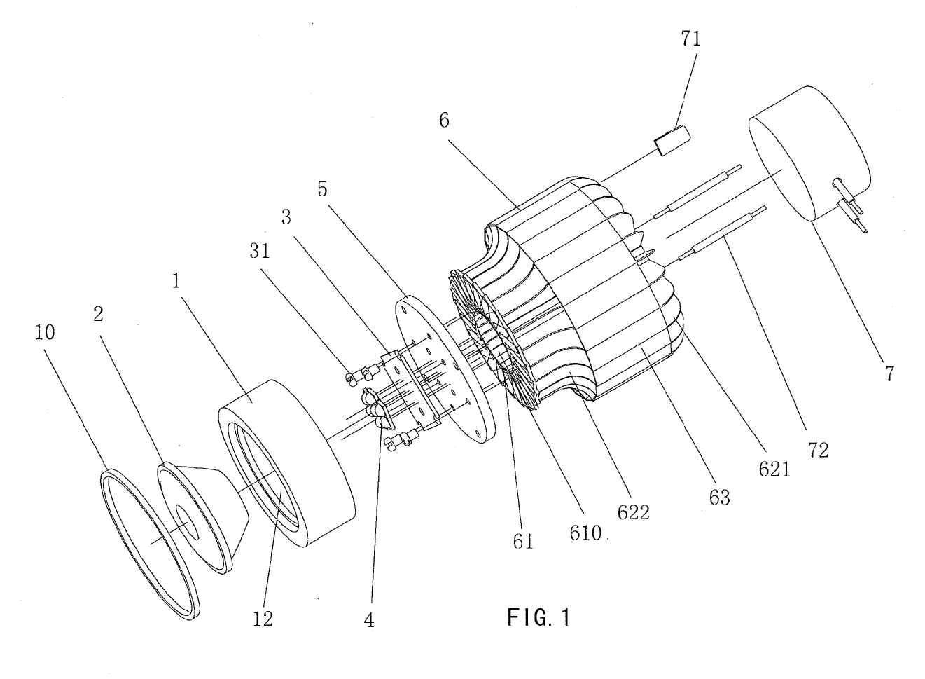

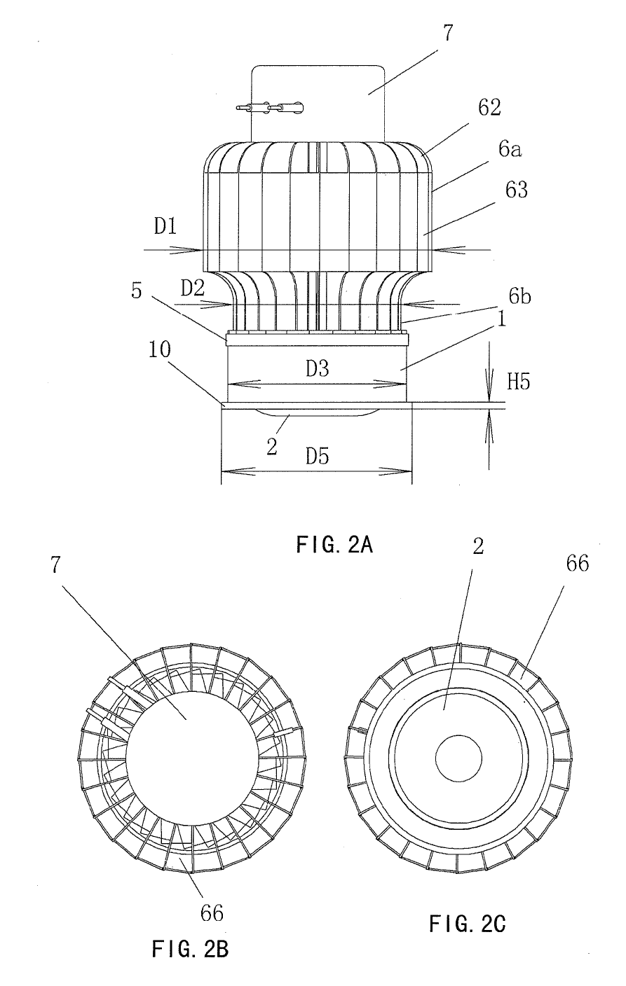

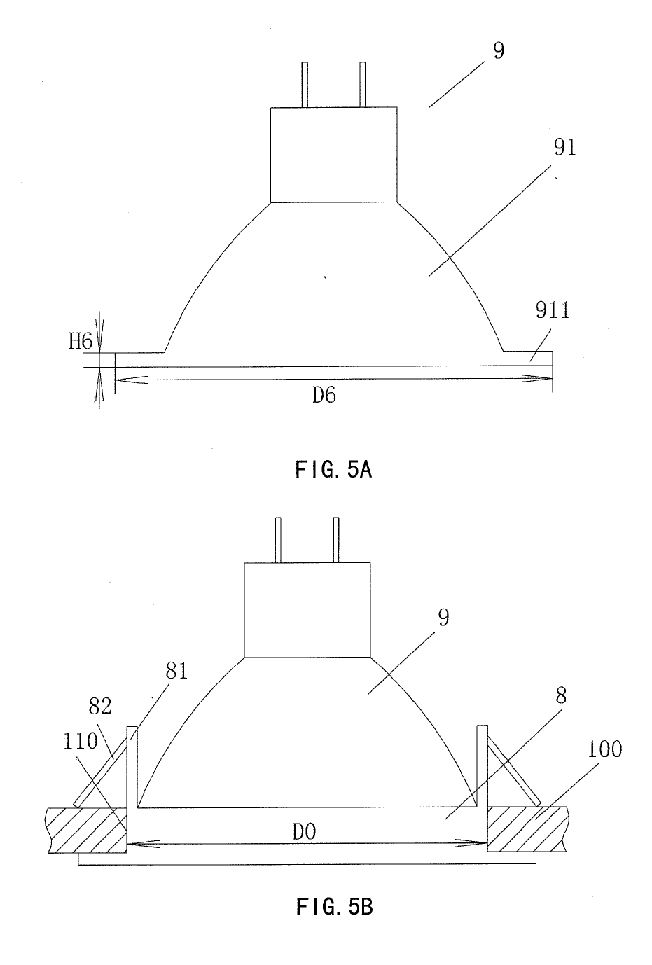

As shown in FIG. 1 to FIG. 2C, the LED bulb of the invention for replacing the reflect cup shaped halogen comprises a shell 1, a collective lens 2, a LED circuit board 3, one or more LED chips 4 arranged on said LED circuit board 3, an radiator 6 and a driver 7. The shell 1, the radiator 6 and the driver 7 are connected to each other from bottom to top in sequence. On the driver there is disposed an earth jack 71. The shell 1 has a hollow structure. The LED circuit board 3 is disposed within a cavity 12 of the shell 1, and connected to the radiator 6. The collective lens 2 is disposed at a lower end portion of the cavity 12. The heat created by the LED chips 4 is transmitted to the radiator 6, and dissipated through the radiator 6. On a circumferential exterior wall at a lower end of the shell 1 there is disposed a circular ring 10, the circular ring 10 is removably connected to the shell 1. An outer diameter D5 and a height H5 of the circular ring 10 are equal to an outer diameter D6 of the reflect cup of the reflect cup shaped halogen bulb and a height H6 of the annular flange of the reflect cup, respectively (see FIG. 5A), so that the circular ring 10 has the function of the annular flange of the reflect cup of the prior reflect cup shaped halogen bulb; at the same time, the outer diameter of the radiator 6 is less than or equal to the mounting outer diameter D0 of the mounting base (see FIG. 5B),so that the LED bulb of the invention can be mounted within the prior mounting hole for use. In a preferred embodiment, the shell 1 has a cylindrical form, the circular ring 10 is threaded to the shell 1.

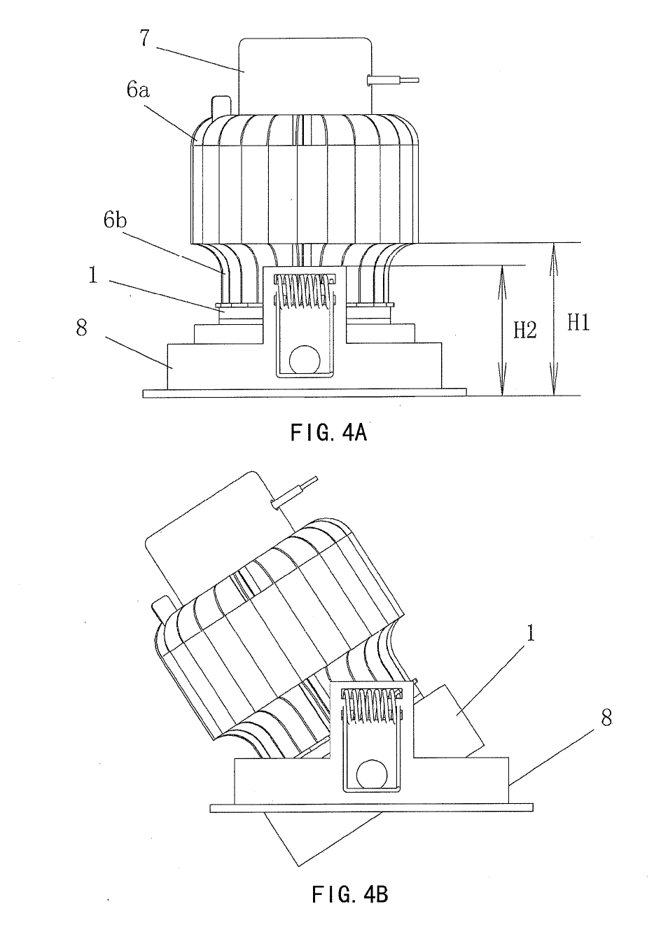

In a preferred embodiment, the radiator 6 is constituted of a central post 61, a plurality of fins 62 disposed on the outer wall of the central post 61 in a radiating spaced configuration, and a bossing 63 disposed around the outside of the plurality of fins 62. The material of the radiator can be aluminum. A throughhole 610 is disposed at the center of the central post 61, to increase the heat dissipation area. By disposing the throughhole 63, air can be introduced to flow in the length direction of the gap 66 between the fins, creating an air convection, so as to improve the effect of heat dissipation. Each of the fins 62 is constituted by an upper wing 621 and a lower wing 622 integrated with the upper wing, and a width of the upper wing 621 is larger than that of the lower wing 622, the bossing 63 is disposed at the outside of the upper wing 621. The upper wings 621 of these fins and the bossing 63 constitute the first radiator portion 6a of the radiator 6, and the lower wings 622 constitute the second radiator portion 6b of the radiator 6. Therein, the mounting outer diameter D0 of the mounting base 8, the outer diameter D1 of the first radiator portion 6a (i.e., the outer diameter of the radiator) and the outer diameter D2 of the second radiator portion 6b meet this formula: D2<D1≦D0. It is desirable that the outer diameter D2 of the second radiator portion 6b is less than or equal to the outer diameter D3 of the shell 1. Further, when the LED bulb is mounted to the mounting base 8 of the reflect cup shaped halogen lamp, a distance H1 from the lower end of the first radiator 6a to the bottom face of the mounting base 8 is larger than the height H2 of the mounting base 8, as shown in FIG. 4A. Using the above structure, the heat dissipation area of the radiator can be increased, and the heat dissipation efficiency can be improved, so as to allow the LED bulb of the invention to have the luminance of the prior reflect cup shaped halogen bulb. At the same time, as shown in FIG. 4B, when the LED bulb is mounted to the mounting base 8 of the reflect cup shaped halogen bulb, the LED bulb of the invention is able to freely rotate in the mounting base 8, just like the prior reflect cup shaped halogen bulb, to facilitate the user to adjust the angle of the illumination, because the distance H1 from the lower end of the first radiator portion 6a to the bottom face of the mounting base 8 is larger than the height H2 of the mounting base 8. Preferably, between the shell 1 and the radiator 6 there is disposed a heat dissipation bottom plate 5, the shell is welded with the lower surface of the heat dissipation bottom plate 5, and the LED circuit board 3 is fixed on the lower surface of the heat dissipation bottom plate 5 through a plurality of screws 31, the upper surface of the heat dissipation bottom plate 5 is welded to the central post 61 and fins 62 of the radiator 6. The material of the heat dissipation bottom plate 5 is preferably copper. On the heat dissipation bottom plate 5 there are also disposed throughholes for inserting wires, the wires 72 from the driver 7 are inserted through the central post and the throughholes of the bottom plate, then are connected to the LED circuit board 3. In another embodiment, the LED circuit board 3 can also be connected to the radiator 6 by a conduction film.

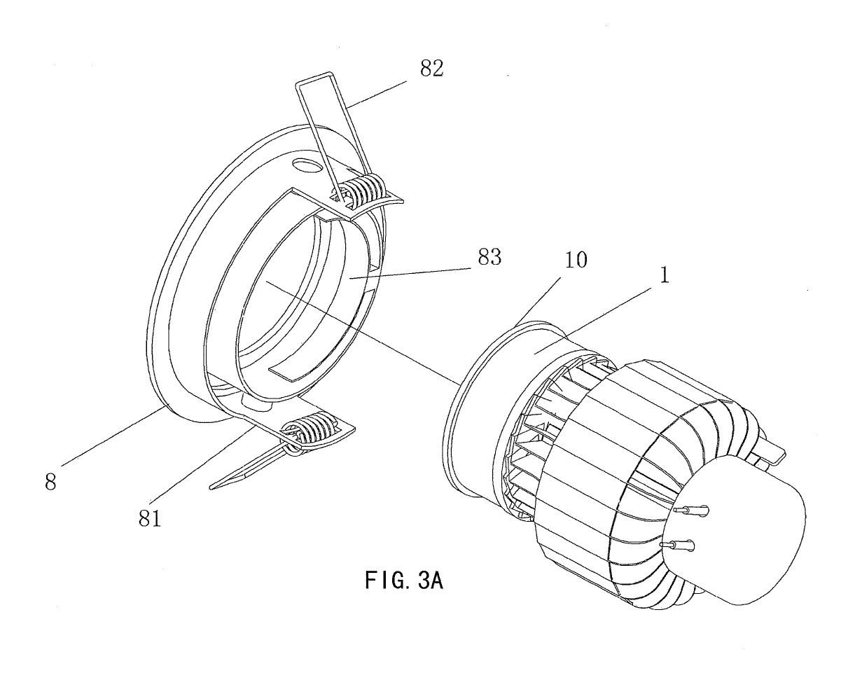

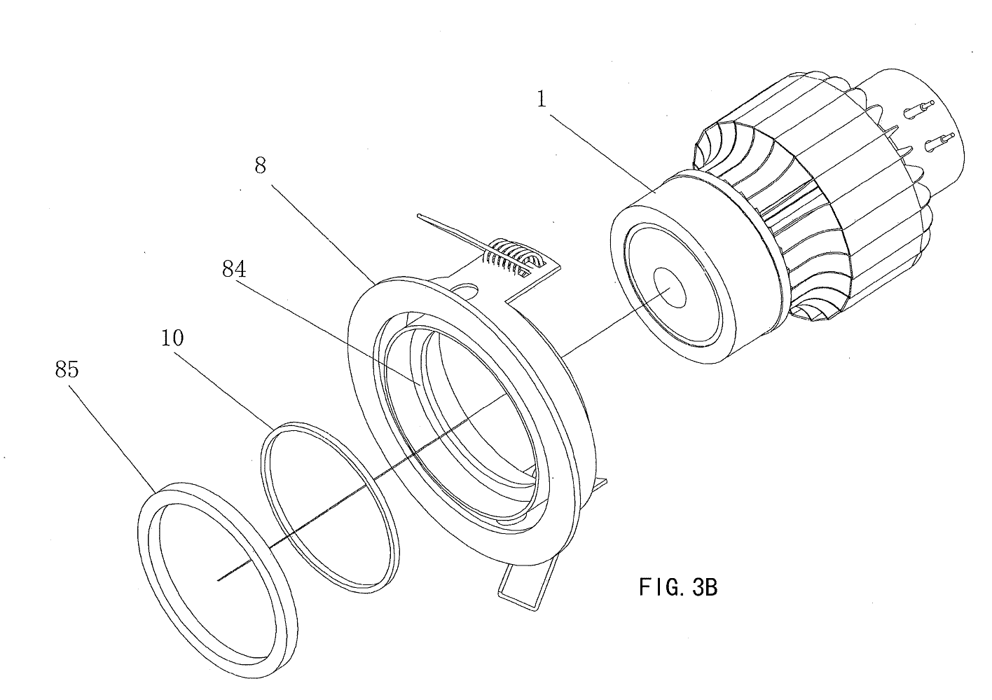

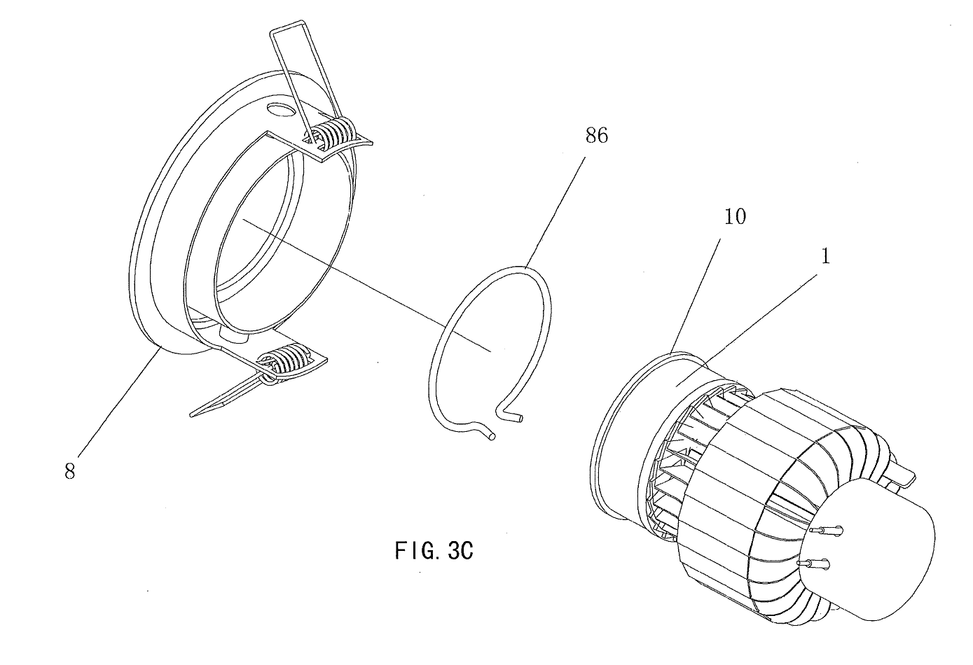

FIGS. 3A, 3B and 3C show the assembly schematic drawings of the LED bulb for replacing the reflect cup shaped halogen bulb of the invention and the prior three kinds of the mounting base of the reflect cup shaped halogen bulb, respectively. In FIG. 3A, after the LED bulb of the invention is placed within the mounting base 8, it is fixed by having a fixing spring 83 disposed on the mounting base 8 to snap on the outer circumferential surface of the shell 1. In FIG. 3B, after the LED bulb of the invention is placed within the mounting base 8, it is fixed by having an annular snap slot 84 disposed on the mounting base 8 and a fixing circular ring 85 to engage with the circular ring 10 of the shell 1. In FIG. 3C, after the LED bulb of the invention is placed within the mounting base 8, it is fixed by having a circular snap spring 86 to snap to the outer circumferential surface of the shell 1, and simultaneously rest on the back surface of the circular ring 10.

Although the description of the invention has made by reference of specific embodiments, those skilled in the art can understand that the invention is not limited to the embodiments herein, and many modifications and variations can be made without departing from the spirit and the scope of the invention. For example, the radiator of the invention is not limited to the manner in which the fins are arranged in the above embodiment, the embodiments of the invention are not used to exert a limitation that, the invention can only be implemented by the fins structure of the embodiment.

### INDUSTRIAL APPLICATION

The LED bulb of the invention can be mounted within the mounting base of the prior reflect cup shaped halogen bulb for use, reducing the inconvenience due to the adaption of the LED bulb by the users of the prior halogen bulb, decreasing the cost. Further, when the LED bulb of the invention is broken down, it only needs to replace the LED bulb without simultaneously replacing the mounting base, so as to avoid the waste of resources. With enabling the LED bulb of the invention to be mounted to the prior mounting base, the radiator structure of the invention has optimized the heat dissipation area and improved the heat dissipation efficiency, so as to allow the LED bulb of the invention to achieve the lumination of the prior reflect cup shaped halogen bulb.

1. A LED bulb for replacing the reflect cup shaped halogen bulb, which can be used with the mounting base of the reflect cup shaped halogen bulb; characterized in that,
the LED bulb comprises a shell, a collective lens, a LED circuit board, one or more LED chips arranged on the LED circuit board, a radiator and a driver;
the shell has a hollow structure; the LED circuit board is disposed within a cavity of the shell and connected to the radiator; the collective lens is disposed at the lower end portion of the cavity of the shell; the shell, the radiator and the driver are connected to each other from bottom to top in sequence;
on a circumferential exterior wall at a lower end of the shell there is also disposed a circular ring, the circular ring is removably connected to the shell, an outer diameter and a height of the circular ring are equal to an outer diameter of the reflect cup of the reflect cup shaped halogen bulb and a height of an annular flange of the reflect cup, respectively;
the outer diameter of the radiator is less than or equal to a mounting outer diameter of the mounting base.

2. The LED bulb for replacing the reflect cup shaped halogen bulb according to claim 1, wherein the radiator comprises a first radiator portion and a second radiator portion located under the first radiator portion and connected thereto; an outer diameter D1 of the first radiator portion and an outer diameter D2 of the second radiator portion meet this formula: D2<D1; and, when the LED bulb is mounted to the mounting base of the reflect cup shaped halogen bulb, a distance from the lower end of the first radiator portion to the bottom face of the mounting base is larger than a height of the mounting base.

3. The LED bulb for replacing the reflect cup shaped halogen bulb according to claim 2, wherein the outer diameter of the first radiator portion of the radiator is equal to the mounting outer diameter of the mounting base.

4. The LED bulb for replacing the reflect cup shaped halogen bulb according to claim 3, wherein the radiator is constituted of a central post, a plurality of fins disposed on the circumferential outer wall of the central post in a radiating spaced configuration, and a bossing disposed around the outside of said plurality of fins; each of the fins is constituted by an upper wing and a lower wing integrated with the upper wing, and a width of the upper wing is larger than that of the lower wing; the bossing is disposed at the outside of the upper wings;
the upper wings of the plurality of fins and the bossing constitute the first radiator portion of the radiator, and the lower wings of the plurality of fins constitute the second radiator portion of the radiator.

5. The LED bulb for replacing the reflect cup shaped halogen bulb according to claim 4, wherein a throughhole is disposed at the center of the central post.

6. The LED bulb for replacing the reflect cup shaped halogen bulb according to claim 4, further comprising a heat dissipation bottom plate disposed between the shell and the radiator, wherein the shell and the LED circuit board are connected to the lower surface of the heat dissipation bottom plate, and the upper surface of the heat dissipation bottom plate is connected to the central post and fins of the radiator.

7. The LED bulb for replacing the reflect cup shaped halogen bulb according to claim 1, wherein the shell has a cylindrical form, and the circular ring is threaded to the shell.
